(19) United States
(12) Patent Application Publication
(10) Pub. No.: US 2010/0310808 A1
(43) Pub. Date: Dec. 9, 2010

(54) RELEASE SHEET AND PRESSURE-SENSITIVE ADHESIVE ARTICLE

(75) Inventors: Shiori Beppu, Saitama (JP); Naoki Taya, Saitama (JP); Toshio Sugizaki, Kanagawa (JP)

Correspondence Address: Ditthavong Mori & Steiner, P.C., 918 Prince Street, Alexandria, VA, 22314, US

(73) Assignee: LINTEC Corporation, Tokyo (JP)

(21) Appl. No.: 12/744,678

(22) PCT Filed: Oct. 30, 2008
(86) PCT No.: PCT/JP2008/070247

§ 371 Date: May 25, 2010

(51) Int. Cl. B32B 33/00; B32B 27/32

(52) U.S. Cl. 428/41.3; 428/523

(57) ABSTRACT

An electrostatic charge on a release sheet is prevented, and thus workability during paying out of a release sheet from a roll is improved.

A release sheet 10 comprises a release sheet base 11, an undercoat layer 12 formed on the release sheet base 11, and a release agent layer 13 formed on the undercoat layer 12. The undercoat layer 12 contains a polyolefin-type antistatic agent with specific surface resistance (ASTM D 257) of less than or equal to 10⁹Ω. The surface resistivity (JIS K 6911) of the release sheet 10 is less than or equal to 10¹⁴ Ω/square.

### TECHNICAL FIELD

The present invention relates to a release sheet in which an undercoat layer contains an antistatic agent, and particularly relates to a release sheet used in the applications of a nameplate label, a low-outgas tape, and so on for a precision electronics device such as a hard disc drive and so on.

### BACKGROUND ART

A release sheet used for a pressure-sensitive adhesive tape is constructed by laminating a release agent layer on a base sheet, and a silicone release agent is used for the release agent layer in general. In the silicone release agent, although the release property is excellent, part of a low-molecular silicone compound is transferred to a pressure-sensitive adhesive, and thus an adherend on which the pressure-sensitive adhesive tape is adhered can be contaminated by the silicone compound. Therefore, when the pressure-sensitive sheet is used in an application for affixing in an electronics device such as a hard disc drive and so on, a malfunction in the electronics device may be induced by silicone contamination.

Accordingly, a non-silicone release agent such as a long-chain alkyl release agent, an alkyd release agent, a fluorinated release agent, a polyolefin release agent and so on is being researched for utilization instead of the silicone release agent in order to prevent a silicone contamination of the electronics device. However, applications utilizing the long-chain alkyl release agent and the alkyd release agent are limited because of their large release force; furthermore, the fluorinated release agent is expensive despite its small release force, and therefore it is difficult to utilize it for a bulk production process. On the other hand, the polyolefin release agent is widely used in applications that require a low release force, since the release force thereof can be made to be small.

However, the release sheet utilizing the polyolefin release agent has a problem in that static electricity is easily charged thereon. Generally a release sheet is wound into a roll-like shape and then stored before bonding to a pressure-sensitive adhesive sheet, for example, but a spark may occur when it is paid out from the roll, or it may become difficult to pay out due to self-adhesion of release sheet itself.

Conventionally, as shown in Patent Citation 1, a release sheet is known in which an antistatic layer is provided on a base in order to prevent an electrostatic charge on the release sheet, and further, an undercoat layer and a release agent layer formed of polyolefin resin are laminated in sequence thereon. The antistatic layer is formed of a metallic foil itself, or is formed by dispersing a metallic powder, an antistatic filler such as a conductive polymer particle and others, or an antistatic agent of a surface-active agent in a binder of polyester, polyamide, acrylic resin, polyurethane, or other.

Patent Citation 1: Japanese Unexamined Patent Publication (KOKAI) No. 2005-350650

### DISCLOSURE OF INVENTION

### Technical Problem

However, the antistatic agent of the surface-active agent has humidity-dependent properties, and thus the surface resistivity of the release sheet changes depending on the humidity in the working environment. Furthermore, the antistatic agents such as the antistatic filler and the surface-active agent, which tend to bleed, can transfer to an adherend and therefore are not preferable for use on an application for an electronics device in which a malfunction can be induced by contamination from a foreign matter. In particular, since a malfunction commonly occurs when the above electronics device is contaminated by a metal, it is difficult to use the release sheet utilizing the metallic powder as the antistatic filler or the metallic foil as the antistatic layer, on an application for electronics device.

Moreover, in Patent Citation 1, there is a problem that the production process is complicated because at least two layers (the undercoat layer and the anti-static layer) should be formed between the base and the release agent layer in order to prevent a static charge.

Therefore, the present invention was created in light of the above problems, and the object of the present invention is to provide a release sheet having the excellent antistatic property without providing a lot of layers between the base and the release agent layer, while the transfer of the antistatic agent to the adherent is mitigated.

### Technical Solution

A release sheet of the present invention comprises a base, an undercoat layer formed on the base, and a release agent layer formed on the undercoat layer, wherein the undercoat layer contains a polyolefin-type antistatic agent with specific surface resistance (ASTM D 257) of less than or equal to 10⁹Ω, so that a surface resistivity (JIS K 6911) of the release sheet is less than or equal to 10¹⁴ Ω/square.

The polyolefin-type antistatic agent is preferably a polyether-polyolefin block copolymer. The undercoat layer is preferably formed of a mixture of at least a polyolefin thermoplastic resin and the polyolefin-type antistatic agent, and the polyolefin thermoplastic resin contained in the undercoat layer contains at least one selected from the group consisting of polyethylene, polypropylene, polybutene, poly(4-methyl-1-pentene), and a copolymer of ethylene and α-olefin with a carbon number of 3 to 10, for example.

The release agent layer preferably contains a polyolefin thermoplastic resin, and the polyolefin thermoplastic resin contained in the release agent layer contains at least one selected from the group consisting of polyethylene, polypropylene, polybutene, poly(4-methyl-1-pentene), and a copolymer of ethylene and α-olefin with a carbon number of 3 to 10, for example. Further, the release agent layer may be laminated on the undercoat layer through one or more other layer (s), but it is preferably laminated on the undercoat layer directly. Furthermore, the release sheet of the present invention preferably contains substantially no silicone compound.

A pressure-sensitive adhesive article of the present invention comprises a release sheet comprising a base, an undercoat layer formed on the base, and a release agent layer formed on the undercoat layer; and a pressure-sensitive adhesive layer that is laminated on the release agent layer and in contact with it, wherein the undercoat layer contains a polyolefin-type antistatic agent with specific surface resistance (ASTM D 257) of less than or equal to 10⁹Ω, and the surface resistivity (JIS K 6911) of the release sheet is less than or equal to 10¹⁴ Ω/square.

The pressure-sensitive adhesive layer is preferably formed of an acrylic pressure-sensitive adhesive, and the pressure-sensitive adhesive article preferably contains substantially no silicone compound either.

### ADVANTAGEOUS EFFECTS

In the present invention, a release sheet that has excellent antistatic properties can be provided while the transfer of the antistatic agent to the adherend is mitigated, by using a polyolefin-type material for the antistatic agent. Furthermore, the antistatic agent has good compatibility with the polyolefin resin, and therefore it is possible to form both the undercoat layer and the release agent layer with a polyolefin resin. Due to this construction, since the adhesion property between the undercoat layer and the release agent layer can be improved, it is not necessary to provide another layer between these layers, and thus a release sheet having an excellent antistatic property can be provided with the simple layered structure.

### BRIEF DESCRIPTION OF DRAWINGS

FIG. 1 is a schematic sectional view showing a release sheet in the present embodiment.

FIG. 2 is a schematic sectional view showing a pressure-sensitive adhesive article in the present embodiment.

### BEST MODE FOR CARRYING OUT THE INVENTION

Embodiments of the present invention will be explained below, in reference to the drawings.

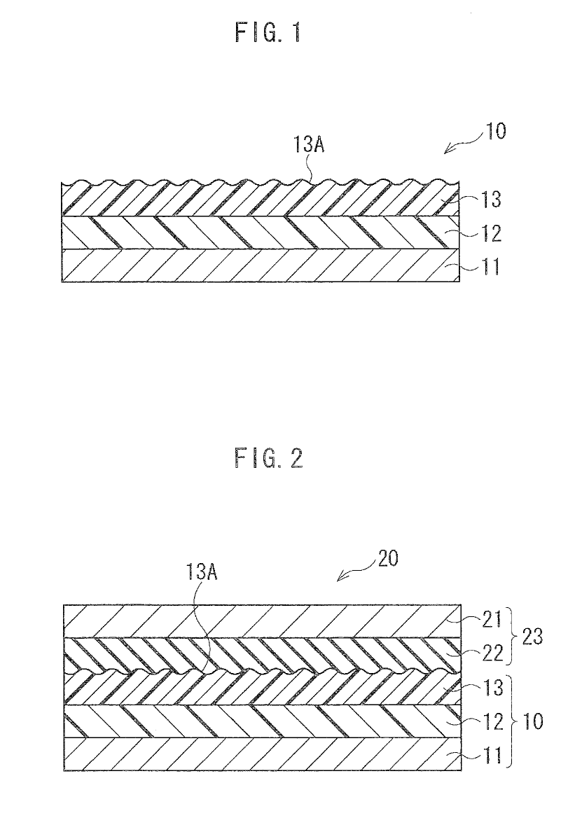

FIG. 1 is a schematic sectional view showing a release sheet in an embodiment of the present invention. FIG. 2 is a schematic sectional view showing a pressure-sensitive adhesive article in the embodiment. As shown in FIG. 1, a release sheet 10 is constructed by laminating an undercoat layer 12 and a release agent layer 13 in sequence, on one surface of a release sheet base 11. However, other layers) may be laminated between the release sheet base 11 and the undercoat layer 12 and/or between the undercoat layer 12 and the release agent layer 13 if necessary.

As shown in FIG. 2, a pressure-sensitive adhesive article 20 is constructed by bonding a pressure-sensitive adhesive sheet 23, which is formed by laminating a pressure-sensitive adhesive layer 22 on a surface of a pressure-sensitive adhesive sheet base 21, to the release sheet 10, such that the pressure-sensitive adhesive layer 22 makes contact with the surface 13A of the release agent layer 13. The release sheet 10 may be wound alone into a roll-like shape and then stored, or it may be wound into a roll-like shape after it is made into the pressure-sensitive adhesive article 20 by bonding it to the pressure-sensitive adhesive sheet 23 and then stored.

The undercoat layer 12, which is formed by melting and then laminating by extrusion an undercoat composition obtained by mixing at least a polyolefin thermoplastic resin and a polyolefin-type antistatic agent onto one surface of the release sheet base 11, is laminated on the release sheet base 11 directly or through other layer(s). The thickness of the undercoat layer 12 is preferably 5 to 50 μm.

As the polyolefin-type antistatic agent contained in the undercoat composition, a block polymer having the structure of a repeatedly and alternating bonded polyolefin block and a hydrophilic block is used; a polyether-polyolefin block copolymer in which the hydrophilic block is a polyether block is preferably used. A specific surface resistance (ASTM D 257) of the polyolefin-type antistatic agent, measured in accordance with ASTM D 257, is less than or equal to 10⁹Ω. The ratio of the polyolefin-type antistatic agent in the undercoat layer 12 is preferably 10 to 50 weight % with respect to 100 weight % of the undercoat composition. The anti-static agent of the present embodiment is highly compatible with the polyolefin thermoplastic resin in the undercoat layer 12 because it contains the polyolefin block. Furthermore, it enables the surface resistivity of the release sheet 10 to be low and constant even in a working environment with variable humidity because it contains the hydrophilic block.

A polyethylene such as low density polyethylene (LDPE, density: greater than or equal to 0.910 g/cm³ and less than 0.930 g/cm³), medium density polyethylene (MDPE, density: greater than or equal to 0.930 g/cm³ and less than 0.942 g/cm³), high density polyethylene (HDPE, density: greater than or equal to 0.942 g/cm³), or others; polypropylene; polybutene; poly(4-methyl-1-pentene); a copolymer of ethylene and α-olefin with a carbon number of 3 to 10; or a mixture of two or more selected from these is used for the polyolefin thermoplastic resin contained in the undercoat composition, but preferably a polyethylene and particularly the low density polyethylene is used in order to maintain a good adhesion property against the release sheet base 11 or the release agent layer 13. Further, the density is measured in accordance with JIS K7112-1999 in this specification. The ratio of the polyolefin thermoplastic resin in the undercoat layer 12 is 50 to 90 weight % with respect to 100 weight % of the undercoat composition.

Due to the undercoat layer 12 containing the predetermined amount of the polyolefin-type antistatic agent with a specific surface resistance (ASTM D 257) less than or equal to 10⁹Ω, the surface resistivity (JIS K 6911; measured on the surface of the release agent layer 13 side) of the release sheet 10, measured in accordance with JIS K 6911, is less than or equal to 10¹⁴ Ω/square. However, the surface resistivity (JIS K 6911) of the release sheet 10 is preferably less than or equal to 10¹³ Ω/square to prevent dust from attaching the surface thereof under static conditions.

The release agent layer 13 is formed, for example, by extrusion lamination of a polyolefin release-agent composition containing a polyolefin thermoplastic resin onto the undercoat layer 12 either directly or through other layer(s). Either polyethylene, polypropylene, polybutene, poly(4-methyl-1-pentene), a copolymer of ethylene and α-olefin with a carbon number of 3 to 10, or a mixture of two or more selected from these is used for the polyolefin thermoplastic resin contained in the release-agent layer composition.

The release agent layer 13 is roughened on a surface 13A, and thereby when the release sheet 10 is peeled away its release force can be determined to be an appropriate value.

A roller etc., with a fine roughness that has been formed on its surface by embossing for example, is impressed on the melted release agent layer 13 to produce the roughness on the surface 13A. However, the surface 13A of the release agent layer 13 may be smooth without roughness. Further, the thickness of the release agent layer 13 is preferably 5 to 50 μm.

The surface roughness Ra of the surface 13A is preferably 100 to 700 nm.

The surface roughness Ra is the arithmetic average measured at 23° C. under the conditions of 50-fold magnification of the objective lens and of 1-fold magnification of the inner lens by an optical interferometric surface roughness meter (brand name: WYKO NT1100, manufactured by Veeco Instruments), based on ANSI/ASME B46.1:1995. If the surface roughness Ra is measured by contact method, there is a risk that the measurement error will be large due to a change in the surface caused by contact because the release agent layer 13 is soft; however, if it is measured by a non-contact method as in the present embodiment, a surface roughness Ra can be obtained with greater accuracy.

The release sheet 10 in the present embodiment is used in an application requiring a relatively low release force, and the release force when the release sheet 10 is peeled away from the pressure-sensitive adhesive sheet 23 is preferably 50 mN/20 mm to 500 mN/20 mm. If the release force is over the above upper limit, the release force becomes so heavy that it can cause a release problem in which a part of the pressure-sensitive adhesive is peeled off together with the release sheet 10. In addition, if the release force is below the above lower limit, the release force can be so light that the pressure-sensitive adhesive sheet 23 may abruptly slip off of the release sheet 10. Further, in this specification, the release force is a value obtained by measurement in accordance with JIS Z0237.

For the release sheet base 11 and the pressure-sensitive adhesive sheet base 21, any bases recognized as conventional bases for the release sheet 10 or for the pressure-sensitive sheet 23 can be appropriately selected and used; for example, a resin film formed of thermoplastic resin etc., a paper, or a complex of these can be utilized. As the pressure-sensitive adhesive for forming the pressure-sensitive adhesive layer 22, a non-silicone pressure-sensitive adhesive can be used without particular limitation; for example an acrylic pressure-sensitive adhesive or other is used.

In the present embodiment, provided that both the release agent layer 13 and the undercoat layer 12 are formed of the polyolefin resin and the pressure-sensitive adhesive layer 22 is formed of the non-silicone resin, the release sheet 10 and the pressure-sensitive adhesive article 20 can be made to contain substantially no silicone compound.

In the present embodiment, since the surface resistivity (JIS K 6911) of the release sheet 10 is less than or equal to 10¹⁴ Ω/square due to the antistatic agent contained in the undercoat layer 12, the electrostatic charge in the release sheet 10 decreases. Accordingly, the workability when the release sheet 10 is paid out is improved, since both sparks and the self-adhesion of the sheet itself are prevented when it is paid out from the roll. Furthermore, since the undercoat layer 12 is formed by mixing the polyolefin thermoplastic resin with a polyolefin-type antistatic agent that is compatible with this resin, the occurrence of the bleeding is particularly mitigated, which can prevent the antistatic agent from transferring to the adherend.

Moreover, since the antistatic agent is mixed and compatible within the olefin undercoat layer 12 which has a good adhesive property with the release agent layer 13, it is not necessary to provide the other layer between the undercoat layer 12 containing the antistatic agent and the release agent layer 13 in order to bond these two together, as in a conventional release sheet. Accordingly, in the present embodiment, provided that the release agent layer 13 is directly laminated on the undercoat layer 12, the layered structure thereof becomes easier compared to the conventional antistatic release sheet.

### Example

Next, the present invention will be explained in further detail with reference to the examples below, but the present invention is not restricted by constitutions of the examples below.

### Example 1

An undercoat composition obtained by mixing 70 parts by weight of low density polyethylene (brand name: Novatec LD LC605Y, manufactured by Japan Polyethylene Corp.) having a density of 0.918 g/cm³ and 30 parts by weight of antistatic agent of polyether-polypropylene block copolymer (brand name: Pelestat 230, manufactured by Sanyo Chemical Industries, Ltd.) was melted and then extruded and coated at a temperature of 320° C. onto a general-purpose PET film (brand name: Lumirror S-28, manufactured by Toray Industries Inc.) having a thickness of 38 μm so that an undercoat layer with thickness of 15 μm was formed. Next, a release agent composition, which was obtained by mixing 70 parts by weight of ethylene-1-butene copolymer (brand name: Excellen EUL731, manufactured by Sumitomo Chemical Co., Ltd) having a density of 0.895 g/cm³ and 30 parts by weight of low density polyethylene (brand name: Novatec LD LC604, manufactured by Japan Polyethylene Corp.) having a density of 0.918 g/cm³ was extruded and coated at a temperature of 280° C. onto the undercoat layer so that a release agent layer with thickness of 20 μm was formed. Then, the release agent layer was impressed against a cooling laminate roller (lami-roller) with an embossed surface, so that a fine roughness (surface roughness Ra: 550 nm) was formed on the surface of the release agent layer while the release agent layer was cooled, and thus the release sheet of Example 1 was obtained. Further, the specific surface resistance (ASTM D 257) of the antistatic agent (brand name: Pelestat 230) was 5×10⁷Ω.

### Example 2

It was demonstrated similar to Example 1, except that a mixture resin obtained by mixing 50 parts by weight of low density polyethylene (brand name: Novatec LD LC605Y) and 50 parts by weight of antistatic agent (brand name: Pelestat 230), was used as its undercoat composition.

### Example 3

It was demonstrated similar to Example 1, except that a mixture resin obtained by mixing 50 parts by weight of low density polyethylene (brand name: Novatec LD LC800, manufactured by Japan Polyethylene Corp.) having a density of 0.916 g/cm³, and 50 parts by weight of ethylene-propylene copolymer (brand name: Tafmer P0280G, manufactured by Mitsui Chemical Inc.) having a density of 0.870 g/cm³ was used as its release agent composition.

### Comparison Example 1

It was demonstrated similar to Example 1, except that a composition composed of only low density polyethylene (brand name: Novatec LD LC605Y), without mixing with any antistatic agent, was used as the undercoat composition for forming the undercoat layer.

[Evaluation of Release Sheet]

The release sheet in each Example and Comparison Example was evaluated by the following methods.

### (1) Release Force

Acrylic pressure-sensitive adhesive (brand name: PL shin, manufactured by Lintec Corp.) was coated onto a PET film having a thickness of 50 μm with a test coater so that a thickness thereof was made to be 23 μm, and then was dried at 120° C. for 1 minute so that a pressure-sensitive adhesive layer was formed so as to obtain a pressure-sensitive adhesive sheet. The release sheet of each Example and Comparison Example was bonded to the pressure-sensitive adhesive sheet such that the release agent layer made contact with the pressure-sensitive adhesive layer, thereby a pressure-sensitive adhesive article was produced, and then the release force of the release sheet in each pressure-sensitive adhesive article was measured in accordance with JIS Z0237.

### (2) Surface Resistivity (JIS K 6911)

The release sheet of each Example and Comparison Example was cut into 100 mm×100 mm and put for 24 hours in the condition of 23° C. in temperature and 50% in humidity, and then the surface resistivity on the surface (the surface of the release agent layer side) of the release sheet was measured in accordance with JIS K 6911.

(3) Workability During Paying Out from Roll

A release sheet having a width of 340 mm and a length of 1000 m was wound around a core having a diameter of 92 mm so as to produce a roll-like shaped release sheet. Then, the workability during paying out from the roll was evaluated by paying out the release sheet from the roll. Good workability due to little electrostatic charge on the release sheet was reported as “∘” in Table 1. On the other hand, in a case where the spark occurred and the release sheet adhered by itself due to the presence of a substantial electrostatic charge, the sheet was difficult to pay out and it was reported as “x”.

TABLE 1

| | | Surface | Workability |
|---|---|---|---|
| | Release Force | Resistivity | during Paying |
| | [mN/20 mm] | [Ω/square] | Out from Roll |
| Ex. 1 | 128 | 4 × 10¹² | ∘ |
| Ex. 2 | 130 | 8 × 10¹¹ | ∘ |
| Ex. 3 | 70 | 6 × 10¹² | ∘ |
| Comp. Ex. 1 | 126 | 3 × 10¹⁵ | x |

As shown in Table 1, in Examples 1 to 3 the electrostatic charge on the release sheet was prevented and thus the workability during paying out from the roll could be improved due to keeping the surface resistivity (JIS K 6911) of the release sheet less than or equal to 10¹⁴ Ω/square by using the polyolefin-type antistatic agent. On the other hand, in Comparison Example 1, since the antistatic agent was not used, the surface resistivity (JIS K 6911) was greater than 10¹⁴ Ω/square, and thus the workability during paying out from the roll was poor.

1. A release sheet comprising:
a base;
an undercoat layer that is formed on said base; and
a release agent layer that is formed on said undercoat layer,
said undercoat layer containing a polyolefin-type antistatic agent with specific surface resistance (ASTM D 257) of less than or equal to 10⁹Ω, the surface resistivity (JIS K 6911) of the release sheet being less than or equal to 10¹⁴ Ω/square.

2. The release sheet as claimed in claim 1, wherein said polyolefin-type antistatic agent is a polyether-polyolefin block copolymer.

3. The release sheet as claimed in claim 1, wherein said undercoat layer is formed of a mixture of at least a polyolefin thermoplastic resin and said polyolefin-type antistatic agent.

4. The release sheet as claimed in claim 3, wherein said polyolefin thermoplastic resin contained in said undercoat layer contains at least one selected from the group consisting of polyethylene, polypropylene, polybutene, poly(4-methyl-1-pentene), and a copolymer of ethylene and α-olefin with a carbon number of 3 to 10.

5. The release sheet as claimed in claim 1, wherein said release agent layer contains a polyolefin thermoplastic resin.

6. The release sheet as claimed in claim 5, wherein said polyolefin thermoplastic resin contained in said release agent layer contains at least one selected from the group consisting of polyethylene, polypropylene, polybutene, poly(4-methyl-1-pentene), and a copolymer of ethylene and α-olefin with a carbon number of 3 to 10.

7. The release sheet as claimed in claim 1, wherein said release agent layer is directly laminated on said undercoat layer.

8. The release sheet as claimed in claim 1, containing substantially no silicone compound.

9. A pressure-sensitive adhesive article comprising:
a release sheet that comprises a base, an undercoat layer that is formed on said base, and a release agent layer that is formed on said undercoat layer; and
a pressure-sensitive adhesive layer that is laminated on and in contact with said release agent layer,
said undercoat layer containing a polyolefin-type antistatic agent with specific surface resistance (ASTM D 257) of less than or equal to 10⁹Ω, the surface resistivity (JIS K 6911) of said release sheet being less than or equal to 10¹⁴ Ω/square.

10. The pressure-sensitive adhesive article as claimed in claim 9, wherein said pressure-sensitive adhesive layer is formed of an acrylic pressure-sensitive adhesive.
